(19) United States
(12) Patent Application Publication
(10) Pub. No.: US 2026/0307946 A1
(43) Pub. Date: Oct. 8, 2026

(54) SLING BASED LIFTING SYSTEM

(71) Applicant: ENDURO SOFTSLINGS B.V., GC De Goorn (NL)

(72) Inventor: Sytse VAN DER MOLEN, GC De Goorn (NL)

(73) Assignee: ENDURO SOFTSLINGS B.V., GC De Goorn (NL)

(21) Appl. No.: 19/157,989

(22) PCT Filed: Feb. 15, 2024
(86) PCT No.: PCT/EP2024/053905

§ 371 Date: Aug. 19, 2025

(30) Foreign Application Priority Data
Feb. 20, 2023 (NL) 2034190

(51) Int. Cl. B66C 1/18; D07B 1/02

(52) U.S. Cl. CPC B66C 1/18; D07B 1/025

(57) ABSTRACT

A method of producing a split eye sling comprises winding high-tenacity continuous filament around a pair of winding posts to form first and second bundles having respective first and second eyes. The bundles are combined together to form a heavy-lift sling wherein at least at a first end of the sling, the bundles are kept separated to form a pair of eyes. A split eye sling and a lifting system using trunnion blocks is also disclosed.

### FIELD OF THE INVENTION

The present invention relates to the field of load carrying slings and in particular, to a method of manufacturing a split-eye sling that allows for balanced load distribution. The invention also relates to a split-eye sling and a lifting system using trunnion blocks that can be implemented in a modular fashion.

### BACKGROUND ART

Load carrying slings are known from the prior art, in particular for use in onshore and offshore heavy lift projects. Over the years lifting and hauling projects become more complex, requiring chains, cables and slings with large lifting capabilities and high precision. Steel cables have largely been replaced with synthetic slings which are lighter, more flexible, and able to sustain heavy loads. The latest sling technology uses high performance fibres that are continuously wound to ensure an exact effective sling length, measured eye to eye. The winding process is to be recognised as a more precise production method in comparison to the more ordinary bundle-rotating process. In the winding process, the fibres are laid parallel by the winding machine, whereby every fibre in a sling bundle is positioned with respect to the designated radius of the eye such that all fibres are subject to the same pre-load and in working situation the same lifting-load. In other words, fibre loops closer to the inner radius of the eye will be shorter than fibre loops closer to an outer radius of the eye. In the following, reference to the eye of a sling refers to the portion designated to receive the lifting-load, irrespective of whether it is a closed eye or an open loop.

However, as they comprise textile fibres, synthetic slings may be susceptible to damage of the fibres by sharp edges or rough surfaces of lifting components or the object to be lifted. Rings, hooks and shackles must also be carefully matched to the sling, in particular with respect to design radius and load-bearing surface. One particular difficulty of conventional metal shackles is their size, weight and handling. Such shackles are used as connecting points between the flexible elements of a lifting system and ultimately the connection to the object to be lifted. They must however be inserted through the eye of the sling and closed with a pin to prevent subsequent removal. For heavy lifting equipment the size of the shackle and pin increases according to the load being lifted, since both the shackle and the pin are subject to the load. Accordingly, assembling the shackle to a sling in the field can be a complex and dangerous process due to the weight of the components. Even the pin can be too big to lift without lifting equipment and the still larger shackle, prior to closure of the pin, is unretained and a potential hazard.

It would be desirable to provide a sling based lifting system that could alleviate at least some of the problems encountered during heavy lifting operations.

### SUMMARY OF THE INVENTION

Therefore, according to a first aspect of the present invention, there is provided a method of producing a split-eye sling for heavy-lift purposes. The split-eye sling comprises two identical matched bundles of a high-tenacity, continuous wound filament that are combined together, while maintaining the eyes at least at one of the ends of the sling separate. The method comprises: setting a pair of winding posts to a pre-defined effective sling length; winding the continuous filament around a first portion of the winding posts a number of turns to complete the first bundle; winding continuous filament around a second portion of the winding posts a number of turns to complete the second bundle; and after completing winding of the first and second bundle, releasing the posts to allow removal of the bundles. The bundles are then combined together to complete the sling, while maintaining at least the first eyes of the first and second bundles separate. In this context, combining the bundles together is intended to denote that the resulting product is a single object, namely a sling that can be tested, certified, hired/sold and used as a single item. As will be discussed further below, such a split-eye sling has significant advantages in ensuring balanced loading.

By winding both bundles on the same posts, without moving the posts between operations, a far tighter tolerance can be achieved between the bundles. In existing winding configurations, single slings are produced in a single winding process. Removing the sling from the posts after winding, requires movement of the posts towards each other. Once moved, a subsequent sling wound on the same posts may not be identical.

One reason for this is the nature of the production process, which requires each set of slings to be custom made for a particular lift operation. The bundles are wound on a winding machine with the posts being set each time to a nominal sling length and a nominal eye radius. Because many different custom sizes are required, the posts do not have fixed positions but must be adjustable to any nominal value. Even if the distance between the posts is accurately measured, it may change during winding due to the forces applied by the wound filament.

In an embodiment, the first and second portions are separated by a dividing region configured to keep the first bundle and the second bundle apart during winding. The dividing region may be a region of the winding posts that is kept free of filament. Alternatively, there may be provided a spacer or collar or flange that keeps the bundles separated. The spacer may be present during winding of both the first and second slings or may be applied only after winding the first bundle and prior to winding of the second bundle. If the eyes at both ends of the sling are all kept separated, then the resulting sling may be referred to as a double-sided split-eye sling.

In another embodiment, only the first post may comprise the dividing region, while first and second portions of the second post may coincide. In such embodiment, the first and second bundles may even be partially intermixed during the winding process such that portions of the first and second bundles overlap around the second post forming an intermixed bundle, while the first and second bundles are separated by the dividing region around the first post forming the separate eyes. The resulting sling may be referred to as a single-sided split-eye sling or a Y-sling. The single-sided split-eye sling comprises a pair of eyes formed at a first end of the central body and a single eye formed at the other end of the central body. In the context of the present invention, reference to eyes is intended to refer to the loop of the sling or bundle as it turns through around 180 degrees about the post or, in use, about an object being lifted. This will generally not be a complete eye and each bundle in the central body of the sling may comprise two separate legs, joining the first and second eyes.

It is possible that the first and second bundles are wound in parallel with a single winding unit applying continuous filament to both of the first and second portions contemporaneously. In a preferred embodiment, the same continuous filament is wound around the first portion until the first bundle is completed and subsequently wound around the second portion of the winding posts to form the second bundle. Using the same filament for both bundles ensures that there cannot be any variation due to the composition of the filament. The filament may be cut between the two bundles but this is not necessary. Since the sling formed from the bundles is intended to be a single sling, the filament may be continuous from one bundle to the other.

In an embodiment, the continuous filament is provided as a multi-filament yarn on a reel. Individually, the monofilaments may be of from 1 dpf to 10 dpf (denier per filament) and may also be lightly entangled or twisted together. Each yarn may comprise from 500 to 5000 monofilaments and be of from 5000 dtex to 50 000 dtex, preferably between 10 000 dtex and 30 000 dtex, and optionally around 24 000 dtex.

Additionally or alternatively, the continuous filament may be provided as a plurality of multi-filament tows bundled together to form a yarn, with each tow being provided from a separate reel. A creel may be provided having from 1 to 20 reels and winding may take place with a corresponding number of multifilament tows. The multiple tows may be parallel i.e. untwisted or lightly twisted with a twist of from 1 twist per meter (tpm) to 25 tpm, preferably around 10 tpm. It will be understood that the greater the number of tows forming the yarn, the less turns will be required on winding the bundle. Nevertheless, it has been found that a certain optimal number of turns may be required to ensure adequate strength and resistance against pull-through. The filaments in the yarn or tows may be all of the same high-tenacity material. Alternatively, they may comprise different materials and a filament or tow of a second different high-tenacity material may be wound together with filament or tow of the first material. Such a yarn may be referred to as a hybrid yarn and the resulting sling may be referred to as a hybrid sling.

In an embodiment, the method may comprise winding the continuous filament at least 30, preferably at least 50 and, more preferably at least 70 times around the pair of winding posts for each bundle. In general, it is preferred that less than 100 turns are applied to each bundle. This has been found sufficient for a stable sling which ensures good force distribution, even if the ends of the filament are not tied off or otherwise secured.

According to one aspect of the invention, the method may further comprise controlling a circumference and/or tension of each turn of the filament around the two posts. As noted above, for custom made slings, it is desirable that each filament, yarn or group of yarns is carefully laid at the correct position in the eye of the sling to ensure the required distribution of load. Each layer that is wound will thus be slightly larger than the layer before. The layers may be wound with exactly the same pre-tension or with varying tension, should that be required.

The sling may be produced to have any required length. The winding posts may be set to a pre-defined sling length of from 2 m to 150 m, preferably from 5 m to 50 m. In certain embodiments, slings may be produced in standard lengths of say 5 m, 10 m, 25 m and 40 m, which can be combined together as outlined below.

In order for the sling to be utilised, it must be provided in a finished form in which it can be used in a lifting environment. The method may comprise combining the bundles together by providing at least one sleeve surrounding the first and second bundles, leaving the eyes exposed. In this context exposed is intended to be with respect to the sleeve. It is not excluded that the eyes may be covered by other means as further explained below. Each bundle may comprise first and second legs connecting the respective first and second eyes. The first and second legs of both bundles can be combined into a single sleeve. Alternatively, the first legs of both bundles can be combined in a first sleeve with the second legs of both bundles being combined in a second sleeve. The sleeve serves to protect the bundles and filaments from abrasion, snagging and the like and ensure that they stay together in an orderly manner. The protective sleeve may comprise textile material such as an abrasion resistant heavyweight polyester fabric. The fabric may have a weight in a range from 400 gsm to 1000 gsm.

The method may also comprise maintaining at least the first eyes of the first and second bundles separate by forming a soft thimble around each of the first eyes. The thimbles may be in the form of protective sleeves, similar to the sleeve surrounding the body of the sling. Each thimble may cover the eye and a portion of the first and second legs of the associated bundle. The sleeve or sleeves may extend to cover a portion of the thimbles, thus completely covering the filament.

Preferably, the thimbles are shaped to the respective eyes. Each may have an inner curvature and an outer curvature, configured to form a wrinkle-free surface in contact with an inner radius of the eye. A length of the thimble at the outer curvature may be greater than the length of the thimble at the inner curvature. In a particular embodiment, the thimbles may be formed of a woven fabric comprising high shrinkage fibres and low shrinkage fibres woven in different positions to achieve the desired curved shape of the thimble.

According to a further aspect of the present invention there is provided a split-eye sling comprising first and second identical bundles of high-tenacity continuous filament combined together to form a heavy-lift sling having a first end and a second end, wherein at least at the first end of the sling, the bundles are separated to form a pair of eyes. The sling may be produced using the method as described above or hereinafter and may be a single-sided split-eye sling or a double-sided split-eye sling. Both bundles may be connected in that the continuous filament is continuous between the bundles.

Each sling may be custom produced to any required size or may be produced in more limited selected ranges of sizes. In certain cases, slings may be produced in standard lengths of say 5 m, 10 m, 25 m and 40 m. The slings may be constructed to have a designated eye radius in a range between e.g. 11 mm and 750 mm, preferably between 100 mm and 500 mm. This generally adequately covers the full range of lifting capabilities of up to MBL (minimum breaking load) of 3500 t.

The sling may comprise a plurality of continuous filaments having a denier per filament in the range of from 1 dpf to 10 dpf. The filament may be present as multi-filament yarns having a weight in a range between 15000 and 30000 dtex, preferably around 24000 dtex. The yarns may be wound individually or as multiple tows together. Such multiple tows may be parallel i.e. untwisted or lightly twisted with a twist of from 1 twist per meter (tpm) to 25 tpm, preferably around 10 tpm. Each filament may be continuous for at least 30, preferably at least 50 and, more preferably at least 70 turns around each bundle. In general, less than 100 turns per bundle will be present. As indicated above, the sling may also be a hybrid sling, having a mixture of different high-tenacity filaments.

The resulting slings may each have a sling core diameter in a range between 30 mm and 250 mm. It will be understood that this will ultimately depend on the weight to be lifted. The slings may each having a minimum breaking load (MBL) of at least 100 t, preferably at least 1000 t, more preferably at least 3500 t.

The material of the continuous filament may be any appropriate material specified for the lifting purpose. In general high-tenacity polymer materials are preferred such as UHMWPE and its equivalents, para-aramids and polyester based fibres such as liquid crystal aromatic polyester (LCP). As indicated above, mixtures and blends of different filaments may be present.

The sling may comprise a sleeve surrounding both bundles but not the eyes. As noted above, each bundle may comprise first and second legs connecting the respective first and second eyes. The first and second legs of both bundles can be combined in a single sleeve i.e. surrounding all four legs. Alternatively, the first legs of both bundles can be combined in a first sleeve with the second legs of both bundles being combined in a second sleeve. The protective sleeve may comprise textile material such as an abrasion resistant heavyweight polyester fabric. The fabric may have a weight in a range from 400 gsm to 1000 gsm.

The sling may also comprise soft thimbles around each of the first eyes maintaining at least the first eyes of the first and second bundles separate. Preferably, each eye of the sling is covered with a respective thimble. The thimbles may be in the form of protective sleeves, similar to the sleeve surrounding the body of the sling. Each thimble may cover the eye and a portion of the first and second legs of the associated bundle. The sleeve or sleeves may extend to cover a portion of the thimbles, thus completely covering the filament.

Preferably, the thimbles are shaped to the respective eyes. Each may have an inner curvature and an outer curvature, configured to form a wrinkle-free surface in contact with an inner radius of the eye. A length of the thimble at the outer curvature may be greater than a length of the thimble at the inner curvature. In a particular embodiment, the thimbles may be formed of a woven fabric comprising high shrinkage fibres and low shrinkage fibres woven in different positions to achieve the desired curved shape of the thimble.

According to another aspect of the present invention there is provided a lifting system comprising a trunnion block having a pair of trunnions and a split-eye sling. A first end of the sling may be connected to the trunnion block with a respective eye encircling a respective trunnion. The other end of the sling may be connected to another trunnion block or to another item of lifting tackle. In this context, lifting tackle is intended to denote any hook, pin, rod, trunnion, trunnion block, shackle or the like that is designated to receive an eye of the sling for performance of the lifting operation. It will also be understood that the eye will not in general completely encircle the lifting tackle but will merely pass partly around it sufficient for lifting, usually along an arc of around 180 degrees. Due to the carefully matched lengths and identical filament compositions of the two bundles, such slings result in an improved load distribution through the trunnion block.

For the proposed lifting system, applying and removing slings is far easier. In the case of conventional shackles, once the pin is removed, the shackle itself is effectively unrestrained and could become detached and fall, resulting in damage or injury. In the case of a trunnion block, the trunnion block is not free during this procedure and no removable pin is required in the line of force. It is noted that auxiliary pins, safety latches or other fasteners may be provided to close the entry to the trunnion block as described below but such pins are not subject to the lifting force.

Although certain advantage of trunnions have been recognised, their implementation in lifting systems has been limited due to a number of difficulties. For trunnion pairs carried by e.g. a central plate, safe operation requires that the slings or cables being used are closely matched regarding effective working length. In historical times, hemp and sisal ropes have been favoured for lifting operations due to their ability to ‘give’ and better distribute load. More recently, ever stronger materials have had the effect that loads must be equally distributed ab initio, since there is less ‘give’ in the system. This is particularly the case for high performance fibre slings. It will be understood that if two slings are applied in parallel through a pair of trunnions to lift a load, if one sling is longer, all of the force will be applied to the shorter sling. This results in a unbalanced force on the trunnions, which in turn results in a bending force on the central plate. For an overall safety margin of 2, this would already be exceeded for the first sling, which could fail. All of the force would then be applied to the other sling, which could also potentially fail.

For this reason, the possibility of using trunnion pairs with high performance fibre slings is dependent on the ability to achieve a high degree of matching between the slings. A specific tolerance in the length difference may be allowed. In ordinary cases, it is recommended that the length difference should be less than half of the sling diameter. In this intended practical lifting situations, a modular lifting system with complex lifting arrangement with branching comprising a larger number of load carrying slings serially connected to a number of spreader elements, this length tolerance is critical for control over limited bending forces in the metal components. Additionally, since load carrying slings for heavy-lift purposes are mostly custom made, it is has been particularly challenging to produce slings with a satisfactory length tolerance. The present split-eye sling partially or completely resolves these difficulties.

Preferably, the split-eye sling is releasably connected to the trunnion block or other lifting tackle. The eyes at the first end of the sling may be simply looped over the respective trunnions. The length over which the eyes are separated will then determine how well the sling is retained to the trunnion block. Additional releasable retention means such as locking pins, safety latches or the like may be provided as further detailed below. It is however not excluded that in certain circumstances the sling may be (semi-permanently) connected or assembled with the lifting tackle e.g. sewn-in using a sleeve or thimble to form a single lifting item.

Although trunnions have been used in the past as attachment points on objects to be lifted, the presently disclosed trunnion block is believed to be distinguished as an item of lifting tackle to be used in a lifting system. Various forms of trunnion block may be contemplated for performing this purpose. In one embodiment, the trunnion block comprises a centre plate having a first end and a second end and the trunnions extend laterally from the first end of the centre plate. The principle of a pair of trunnions is that they are aligned, usually co-axial and of sufficient length and diameter to bear the load that is intended. In the present case, each trunnion may have a radius corresponding to the design radius of the eyes of the sling to which it is to be connected. As noted above, these are contemplated to be from 11 mm to as much as 750 mm, including all sizes in between. The length of each trunnion may be around the same as the diameter e.g. from 22 mm to 1500 mm.

Each trunnion may be provided with a retainer of some sort at its distal end i.e. the end furthest from the centre plate, in order to prevent an eye of the sling from leaving the trunnion accidentally or unintentionally e.g. when not under load. Preferably, the retainer is in the form of a retention plate, which may be arranged parallel to the centre plate. The retention plate may extend radially from the trunnion by an amount corresponding to the thickness of the bundle forming the eye. In general, it may extend slightly further, thus protecting the eye, from impact, abrasion or becoming trapped. The retention plates may extend radially in all directions from the trunnion and may have any suitable shape especially round or rectangular. In an embodiment, the retention plates may be of a shape and size corresponding to the first end of the centre plate.

Additional means may be provided to prevent unintended or uncontrolled release of the sling. These may comprise one or more locking pins or safety latches that extend from the retention plates to the centre plate. The locking pins are not intended to be load bearing or in any way structural components of the lifting system and may thus be light to handle even for the heaviest lifting tackle.

The trunnion block may take various configurations, depending on the remainder of the lifting system. The centre plate may have any particular shape and need not necessarily be a straight, flat member, as long as it can support the trunnions in an orientation to receive the eyes of the sling. In a preferred embodiment, the centre plate is an elongate, flat plate defining a centre plane of the trunnion block. The forces applied through the trunnion block should be equally divided on either side of the centre plate, which is thus loaded in tension only in the plane of the plate.

In an embodiment, the centre plate is elongate and comprises an attachment point at the second end, for attachment to another item of the lifting system. The attachment point may be a bore for pivoting attachment to a portion of lifting tackle or an object to be lifted. The attachment point may be releasable e.g. in the form of a pin. In one preferred embodiment, the attachment point comprises a second pair of trunnions. A second split-eye sling may be provided and such a double-ended trunnion block can serve to connect the first sling to the second sling. An axis of the second pair of trunnions may be parallel to an axis of the first pair of trunnions. This will be particularly the case for a flat centre plate.

The lifting system may be used as part of a bigger system comprising further trunnion blocks, slings, split-eye slings, lifting hooks, spreader beams and the like. In particular, the use of such items allows a modular system to be provided comprising sets of matched slings. Spreader beams or other parts of the lifting system, including the load, may be provided with trunnions to which split-eye slings can be directly connected. Alternatively, they may be provided with trunnion blocks, which may be captive or removable. Standard length split-eye slings can be combined and/or extended using double-ended trunnion blocks. As indicated above, a range of standard length slings can be produced allowing a wide variation in overall length. Slings of 5 m, 15 m, 25 m and 40 m allow lifting lengths covering most multiples of 5 m but alternative length intervals may be contemplated. Slings may be provided to have a measured length calculated to a mid-point of a trunnion block. Additionally or alternatively, trunnion blocks having different lengths may be provided to ensure that intermediate lengths can be achieved.

According to a still further aspect of the present invention there is provided an apparatus for winding a split-eye sling. The apparatus may comprise: a frame; a pair of winding posts, engageable with the frame to define a predetermined sling length and releasable to allow removal of the bundles after winding; a winding unit, traversable on the frame to wind a continuous filament around the winding posts to form the bundles; wherein each winding post can comprise a first portion for the first bundle and a second portion for forming the second bundle. At least one post, and preferably both posts, may further comprises a dividing region separating the first portion and the second portion, which keeps the bundles separated until release of the winding posts. The winding machine allows manufacture of split-eye slings as described above and hereinafter.

The dividing region may be an otherwise uniform region of the winding posts that is kept free of filament. Alternatively, there may be provided a spacer or collar or flange that keeps the bundles separated. The spacer may be integral with the post or attached thereto, optionally at an adjustable location. Such a spacer may be present during winding of both the first and second slings or may be applied only after winding the first bundle and prior to winding of the second bundle.

The winding unit may comprise a moveable platform having a creel with at least one reel of the continuous filament. The platform may be arranged to move in any appropriate manner, either reciprocating along the frame or following a continuous path in the direction of winding. In an embodiment, the frame may comprise one or more rails and the moveable platform may be configured to move along the rails.

The winding unit may dispense filament from a single reel. In an alternative, a number of reels may be provided together. In general, reference to a creel is intended to denote multiple reels mounted to dispense filament or yarn for winding by the winding unit. The creel may be provided with appropriate guides for the filaments or yarn and may or may not be arrange to provide a twist to the respective yarns being dispensed. A yarn tensioner may be provided for each reel in the creel. The yarn tensioner may be any appropriate controller to accurately control, the tension or the speed of delivery of the yarn. An additional central control unit may be provided to match the speed of the movement of the winding unit along the frame to the delivery speed or tension at the yarn tensioners. In an embodiment, the control unit may also control the position of the continuous filament on the posts during winding, in particular the height of each turn of the filament around the respective post.

In one embodiment, the apparatus is configured to wind the continuous filament first around the first portion and subsequently around the second portion. This may be carried out using a single winding unit. In an alternative, the apparatus may comprise more than one winding unit. These may each run on the same track or on parallel tracks provided on the frame. In an embodiment, two winding units are provided, configured to form the bundles in parallel.

The winding posts may be adjustable in any suitable way to provide for the predetermined sling length. Either one or both may be releasable such that the relative spacing between the posts can be reduced for removal of the slings after winding. In this sense, adjustment of the position of the posts by moving of part of the frame carrying the post is also intended to be covered by this term. In one embodiment an actuator may be provided to displace the winding posts in order to set a distance between the winding posts corresponding to the predetermined sling length. The actuator may be any suitable adjustment mechanism including a motorized unit, a hydraulic unit, a screw and nut or the like.

### BRIEF DESCRIPTION OF THE DRAWINGS

The present invention will be discussed in more detail below, with reference to the attached drawings, in which:

FIG. 1 depicts a lifting system according to the invention;

FIG. 2 depicts a split-eye sling as used in the system of FIG. 1;

FIG. 3 depicts a single-sided trunnion block;

FIG. 4 depicts a double-sided trunnion block;

FIGS. 5A to 5C depict views of a further embodiment of a double-sided split-eye sling;

FIG. 6 is a side view of a single-sided split-eye sling;

FIG. 7 shows the sling of FIG. 5, mounted to a single-sided trunnion block

FIG. 8 shows two slings according to FIG. 2 mounted to the double-sided trunnion block of FIG. 4;

FIG. 9 is a top view of an apparatus for winding the slings of the present invention;

FIG. 10 depicts a perspective view of the apparatus of FIG. 9, including the winding unit;

FIG. 11 depicts a side view of the apparatus of FIG. 9, including the winding unit; and

FIG. 12 is an enlarged schematic side view of part of the apparatus of FIG. 9 during winding of a sling.

### DESCRIPTION OF EMBODIMENTS

The invention will be explained in more detail below with reference to drawings in which illustrative embodiments thereof are shown. The drawings are intended exclusively for illustrative purposes and not as a restriction of the inventive concept which is to cover all modifications, equivalents, and alternatives falling within the scope of the present invention. The scope of the invention is only limited by the definitions presented in the appended claims.

In the drawings, like numerals designate like elements. Multiple instances of an element may each include separate letters appended to the reference number. For example, two instances of a particular element “48” may be labelled as “48A” and “48B”. The reference number may be used without an appended letters (e.g. “48”) to generally refer to an unspecified instance or to all instances of that element.

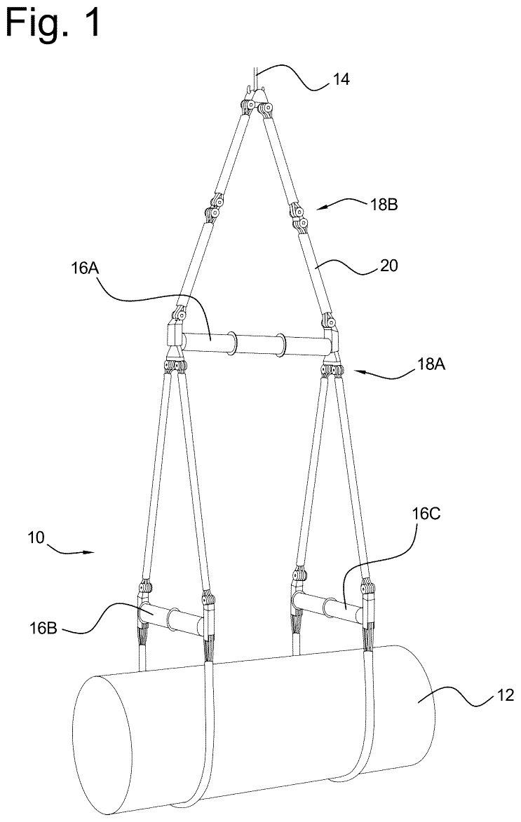

FIG. 1 illustrates a part of a lifting system 10 according to the present invention as used for lifting a load 12. The lifting system 10 includes a hook 14, three spreader beams 16 A-C used for branching the lifting system 10 out from the hook 14 down to the load 12, a number of slings 20 connected to the hook 14 and/or the spreader beams 16 and a number of single-sided trunnion blocks 18A and double ended trunnion blocks 18B.

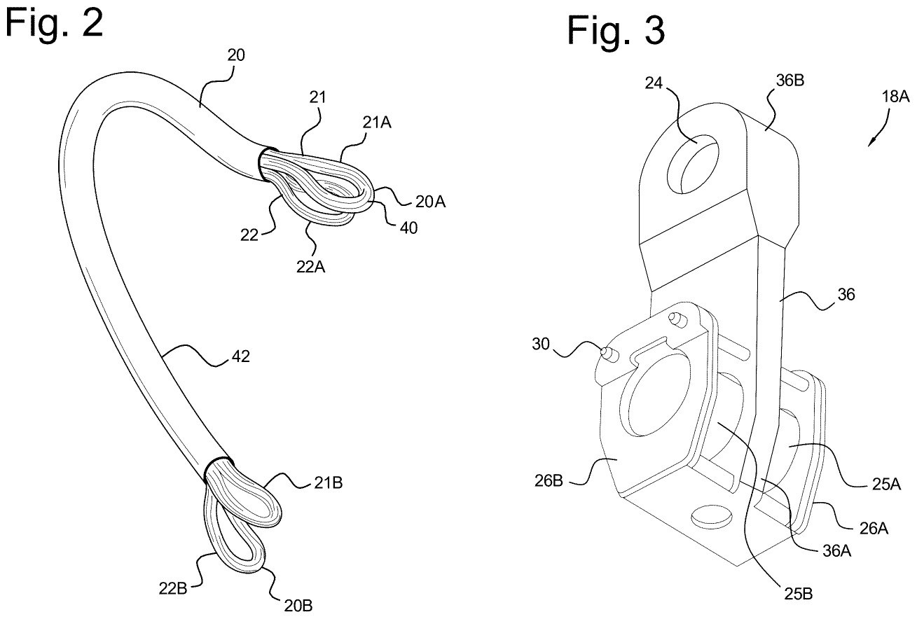

FIG. 2 shows one of the slings 20 of FIG. 1 in further detail. The sling 20 comprises first and second identical bundles 21, 22 of high-tenacity continuous filament yarns 40, combined together to form a heavy-lift sling 20 having a first end 20A and a second end 20B. The bundles 21, 22 are kept separated at both the first and second ends 20A, 20B to form two pairs of eyes 21A, 22A, 21B, 22B at the first end 20A and at the second end 20B respectively of the sling 20. The sling 20 may thus be referred to as a double split-eye sling.

Between the two ends 20A, 20B, the bundles 21, 22 are combined together within a sleeve 42. In the illustrated embodiment of FIG. 2, a single sleeve 42 completely surrounds both bundles 21,22. Alternative arrangements may be provided as further illustrated below. Also, according to the illustrated embodiment, the eyes 21A, 22A, 21B, 22B are uncovered, revealing the yarns 40. As discussed further below, it is preferred that the eyes 21A, 22A, 21B, 22B are also covered by soft thimbles 38 to protect the yarns 40 and their filaments 41.

A single-sided trunnion block 18A is shown in FIG. 3. The trunnion block 18A has a centre plate 36 extending from a first end 36A to a second end 36B. A coupling bore 24 is provided at the second end 36B, which serves as an attachment point and allows the trunnion block 18A to be connected to another component in the lifting system 10 such as a spreader beam 16. The first end 36A of the centre plate 36 carries a pair of trunnions 25A, 25B extending laterally on either side of the centre plate 36.

The trunnions 25A, 25B each carry a retention plate 26A, 26B at their respective distal ends i.e. distant from the centre plate 36. Locking pins 30 extend through the retention plates 26A, B and also through the centre plate 36.

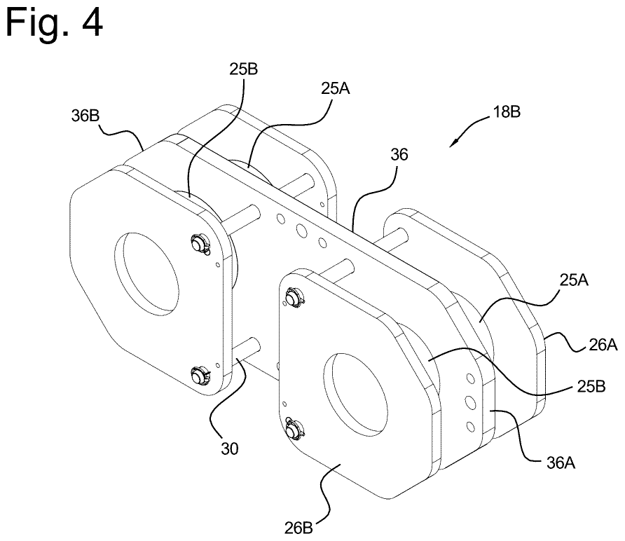

A double-sided trunnion block 18B is shown in FIG. 4. The double-sided trunnion block 18B has most features identical to the single sided trunnion block 18A of FIG. 3 and like reference numerals are used as appropriate. The trunnion block 18B also has a centre plate 36 extending from a first end 36A to a second end 36B. The first end 36A of the centre plate 36 carries a pair of trunnions 25A, 25B extending laterally on either side of the centre plate 36 having retention plates 26A, 26B at their respective distal ends and locking pins 30.

The double-sided trunnion block 18B is distinguished over the single-sided trunnion block 18A in that it is also provided with trunnions 25A, 25B at the second end 36B of the centre plate 36 instead of a coupling bore. The illustrated double-sided trunnion block 18B is thus essentially symmetric. It will however nevertheless be understood that non-symmetric double-sided trunnion blocks 18B may be contemplated in which the trunnions 25 at the first end 36A of the centre plate 36 are of different dimensions to those at the second end 36B.

In the illustrated embodiments, the trunnions 25 are illustrated to be hollow and round in cross-section. The skilled person will nevertheless understand that other shapes are possible and that the cross-section may be solid or hollow.

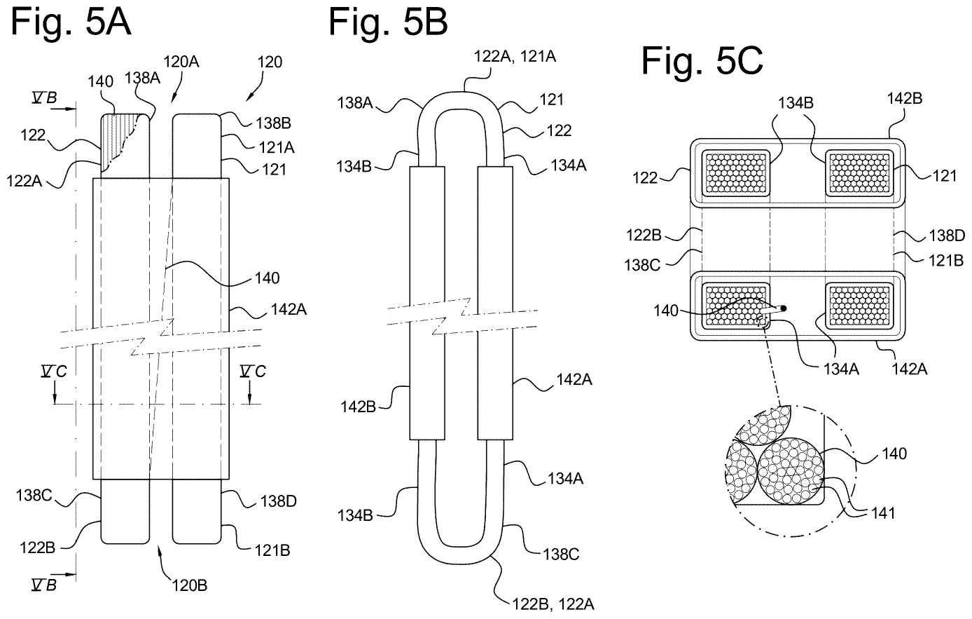

FIGS. 5A and 5B are side and front views respectively of an alterative double split-eye sling construction according to a second embodiment, in which like reference numerals preceded by 100 are used to refer to similar elements corresponding to FIG. 2.

In FIG. 5A, sling 120 comprises first and second identical bundles 121, 122 of high-tenacity continuous filament yarn 140 and having a first end 120A and a second end 120B. As in the earlier embodiment, the bundles 121, 122 are kept separated at both the first and second ends 120A, 120B to form separate eyes 121A, 122A, 121B, 122B. The eyes 121A, 122A, 121B, 122B are all provided with protective soft thimbles 138 A-D of which thimble 138A is partially cut away to reveal the yarns 140.

FIG. 5B is a front view of FIG. 5A, taken in the direction Vb. In this view it can be seen that the bundles 121, 122 each have first and second legs 134A, B extending between the eyes 121A, 122A, 121B, 122B. The first legs 134A of both bundles are combined in a first sleeve 142A. The second legs 134B of both bundles are combined in a second sleeve 142B. The legs 134 may be of any chosen length as indicated elsewhere.

In this embodiment, it can also be seen in FIG. 5A that although the sling 120 comprises separate bundles 121, 122, the yarn 140 is continuous between the two bundles 121, 122. This is shown in a broken line through the first sleeve 142A between the respective first legs 134A. It will be understood that the same may apply to the embodiment of FIG. 2 but that it is equally possible that the bundles 121, 122 are fully separate in terms of the yarn 140 and are only combined by virtue of the sleeves 142A, B.

FIG. 5C is a cross-section through the sling 120 in the direction Vc-Vc in FIG. 5A. It shows the first legs 134A of both bundles 121, 122 combined within the first sleeve 142A and the second legs 134B of both bundles 121, 122 combined in the second sleeve 142B.

In this view, the thimble 138C can be seen surrounding the eye 122B of the second bundle 122 as can the thimble 138D, surrounding the eye 121B of the first bundle 121. The thimbles 138C, 138D are overlapped by the respective sleeves 142A, B. The yarn 140 can also be seen in cross-section, including the portion connecting the first bundle 121 to the second bundle 122. It will be understood that the yarn 140 is continuous through the whole sling 120 and the multiple sections through the yarn 140 are all the same yarn 140, representing the multiple loops that is completes around the sling 120. Within the yarn 140, the individual filaments 141 can also be seen.

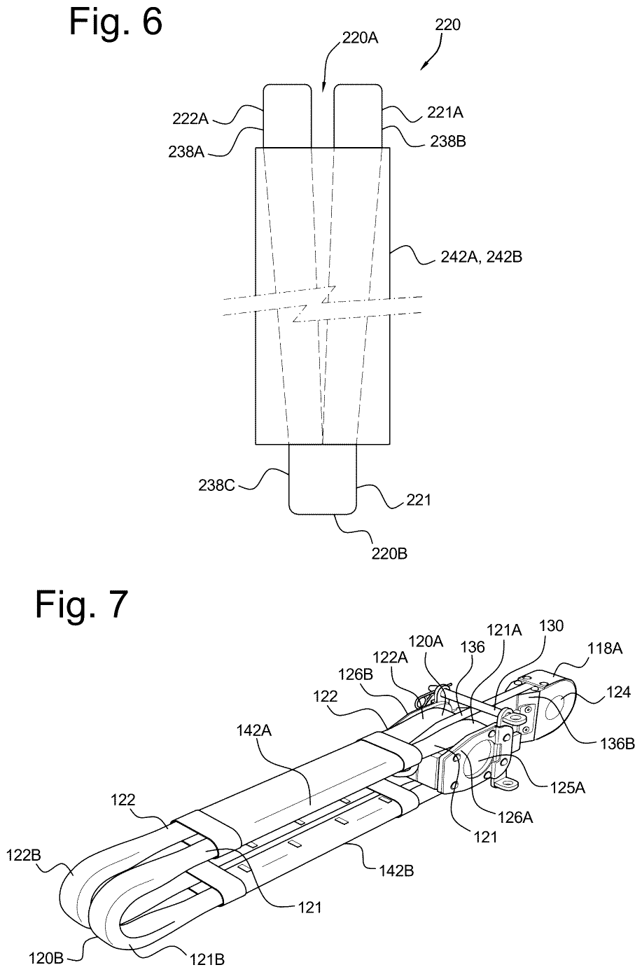

FIG. 6 shows a view similar to that of FIG. 5A but for a single-sided split-eye sling 220. As in the earlier embodiments, the sling 220 comprises first and second identical bundles 221, 222 having a first end 220A and a second end 220B. As in the earlier embodiment, the bundles 221, 222 are kept separated at the first end 220A. to form separate eyes 221A, 222A. At the second end 220B however, the bundles 221, 222 are combined together into a single eye 221. The point at which the bundles 221, 222 combine is located within sleeves 242A, B, which are applied to the slings as in the embodiment of FIG. 5. It will be understood that a front view of FIG. 6 would be identical to that of FIG. 5B. Nevertheless, at the second end 220B only a single thimble 238C is present. It will be understood that the single-sided split-eye sling of FIG. 6 may be used to connect between a trunnion block and a conventional lifting element such as a hook or shackle.

A split eye sling 120 corresponding to FIG. 5 is shown in FIG. 7 mounted to a single-sided trunnion block 118A similar to that of FIG. 3. Like elements to those of FIG. 3 are provided with like reference numerals preceded by 100.

The first end 120A of sling 120 is mounted to the trunnion block 118A with the eye 121A of the first bundle 121 around the first trunnion 125A and the eye 122A of the second bundle 122 around the second trunnion 125B (not shown). The eyes 121A, 122A are held captive between the centre plate 136 and the retention plates 126A, 126B by locking pins 130 extending through the retention plates 126A, 126B. This embodiment is slightly distinct from the first embodiment of the trunnion block 18A in that the retention pins 130 do not pass through the centre plate 136.

The coupling bore 124 at the second end 136B of the centre plate serves as an attachment point for the trunnion block 118A to be connected to e.g. the spreader beam 16 as illustrated in FIG. 1. At the second end 120B of the sling 120, the eyes 121B, 122B of the respective first and second bundles 121, 122 are free to be connected to another trunnion block (not shown), which may be either single or double-sided.

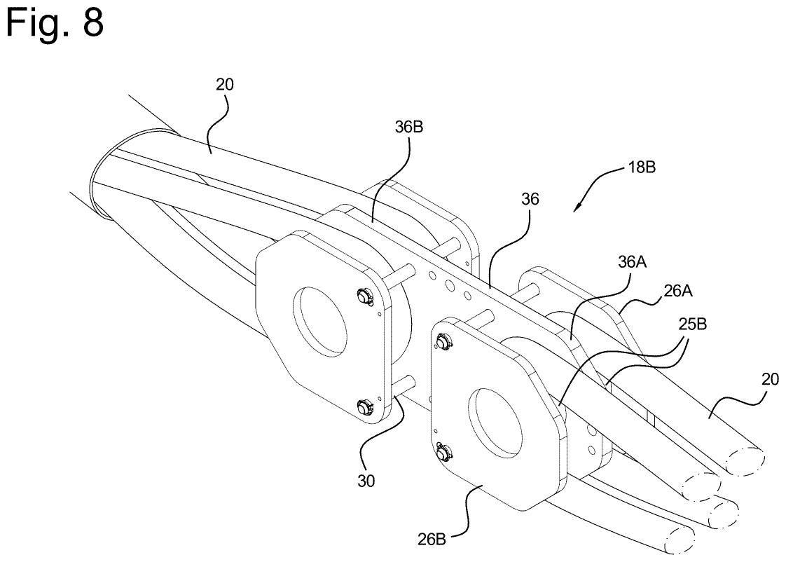

FIG. 8 illustrates how a double-ended trunnion block 18B according to FIG. 4 can be used to connect together two slings 20. The trunnion blocks 18A, 18B provide modularity to the lifting system, as can be seen from FIGS. 1, 7 and 8. When combined with e.g. spreader beams 16 and other lifting tackle, trunnion blocks 18 allow for a fast and secure assembly of a custom lifting system designed according to the shape and/or weight of the load 12 to be lifted.

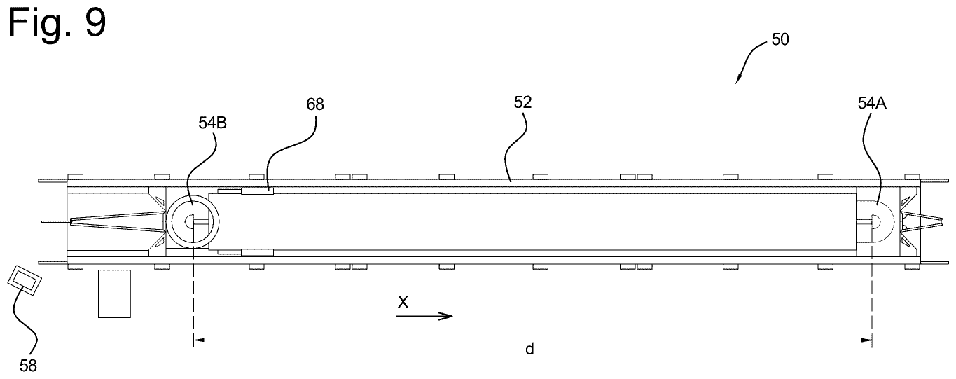

To produce the slings 20, an apparatus 50 as shown in FIGS. 9-11 may be used. The apparatus 50 has a frame 52, two winding posts 54A, 54B, a winding unit 56, and a control unit 58. The sling 20 is produced by winding the yarn 40 around the two winding posts 54A, 54B.

The apparatus 50 in FIG. 9 is shown without the winding unit 56 to illustrate positions of the two winding posts 54A, 54B. The first winding post 54A is fixed to the frame 52 while the second winding post 54B is movable along the frame 52. Additionally, the second winding post 54B is connected to a positioning unit 68, which may be a hydraulic actuator. The positioning unit 68 is controlled by the control unit 58. Depending on the length L of the slings to be produced, the positioning unit 68 moves the second winding post 54B along the frame 52 to set a distance d between the two winding posts 54A, 54B corresponding to the length L. For example, the distance d may be 9 m. Once the correct distance is achieved, a position of the second winding post 54B is fixed and the winding of the pair of matched slings 20 may begin.

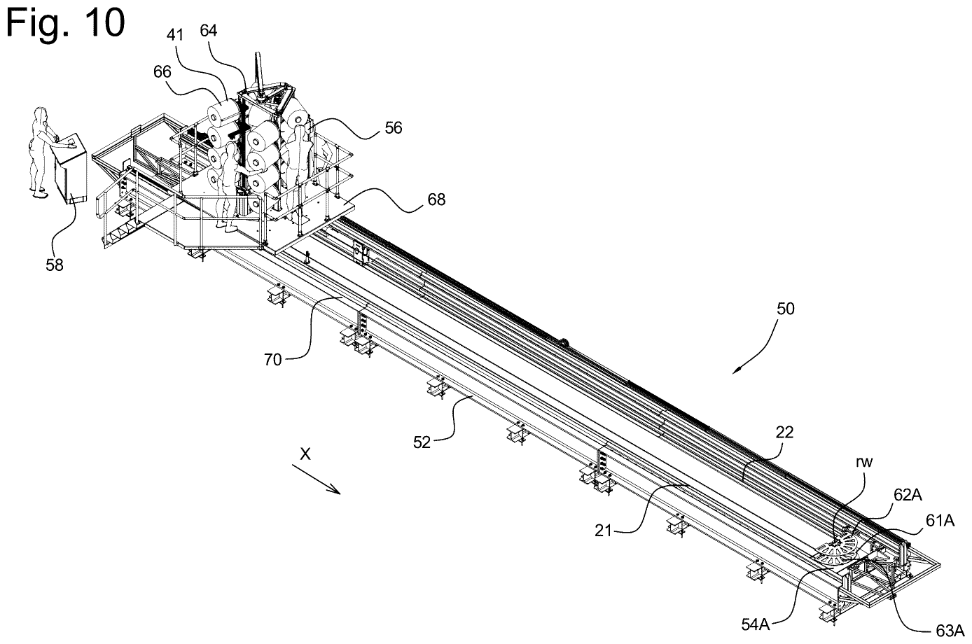

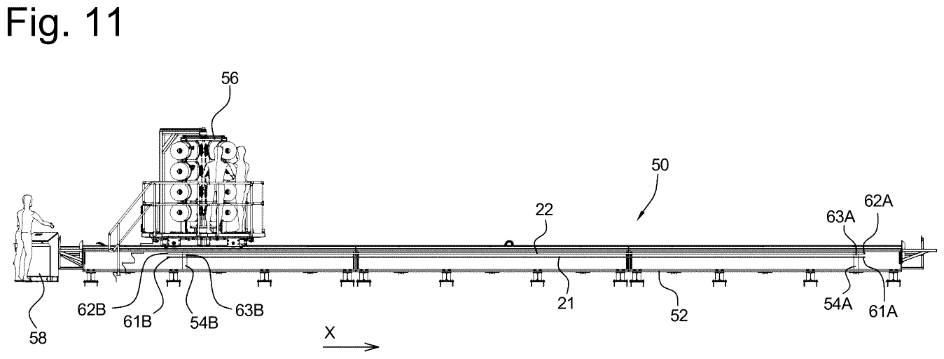

FIGS. 10 and 11 show the apparatus 50 with the winding unit 56 in a perspective and a side view, respectively, with the yarn 40 being wound around the two winding posts 54A, 54B. Each of the two posts has a first winding region 61A, 61B, a second winding region 62A, 62B, and a dividing region 63A, 63B located in between them. The first winding region 61A, 61B and the second winding region 62A, 62B have the form of a semi-circle and a winding region radius rw corresponding to the eye radius r of the sling being produced. The first bundle 21 is wound in between the two first winding regions 61A, 61B and the second bundle 22 is wound in between the two second winding regions 62A, 62B. The first bundle 21 and the second bundle 22 are thus separated by the dividing region 63A, 63B during the winding procedure.

The winding unit 56 comprises a creel 64 having a number of reels 66 carrying tows of multiple filaments 41, which are combined together and exit the creel as yarn 40. Constant speed or constant tension feeders are provided for each reel, ensuring that the individual tows are delivered with the same, accurate and constant speed or tension. Such feeders are well known in the art of filament and yarn delivery and will not be further discussed here. The creel 64 is placed on a movable platform 68 which moves along rails 70 placed along the frame 52. As the moveable platform 68 moves, the yarn 40 is wound between the two winding posts 54A, 54B. The movement of the moveable platform 68 and the winding of the yarn 40 is controlled by the control unit 58. In this process, the yarn 40 is first wound between the first winding regions 61A, 61B of the two winding posts 54A, 54B until the first bundle 21 is formed.

Upon finishing the first bundle 21, the winding unit 56 continues by winding the yarn 40 between the second winding regions 62A, 62B of the two winding posts 54A, 54B to form the second bundle 22. As previously discussed, the yarn 40 and its individual filaments 41 may be continuous from the first bundle 21 to the second bundle 22. It is also possible to separate the yarn 40, prior to commencing the second bundle 22.

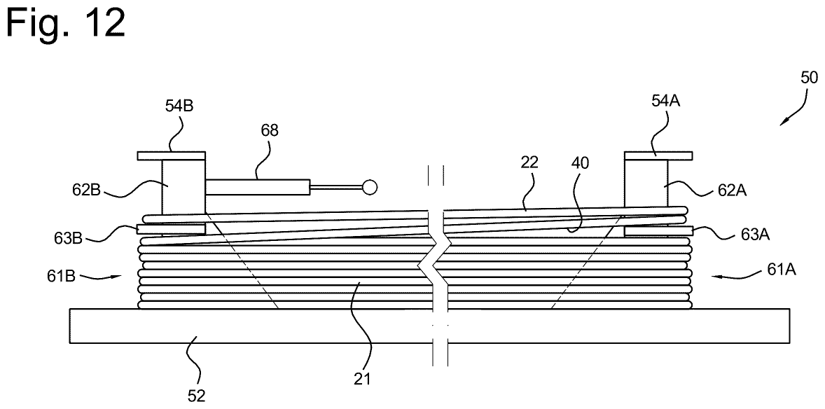

FIG. 12 shows schematically an enlarged side view of parts of the apparatus 50, illustrating the situation during winding of the sling 20 around the winding posts 54A, 54B. According to FIG. 12, the first bundle 21 has been fully wound onto the first winding regions 61A, 61B. The yarn 40 has then traversed the dividing regions 63A, 63B and a first few loops have been wound around the second winding regions 62A, 62B.

During winding, the placement of the yarns in the first bundle 21 and the second bundle 22, are carefully controlled by the control unit 58, in particular the position of the yarns around the posts 54A, 54B. Upon finishing the matched bundles 21, 22, the second winding post 54B is released from its fixed position and moved by the positioning unit 68 towards the first winding post 54A to remove the sling 20 from the apparatus 50. Thereafter, the sling 20 can be completed by installation of sleeves 42 and thimbles 38.

The present invention may be embodied in other specific forms without departing from its essential characteristics. The described embodiments are to be considered in all respects only as illustrative and not restrictive to the inventive concept. The scope of the invention is, therefore, indicated by the appended claims rather than by the foregoing description. It will be apparent to the person skilled in the art that alternative and equivalent embodiments of the invention can be conceived and reduced to practice. In addition, many modifications may be made to adapt a particular configuration or material to the teachings of the invention without departing from the essential scope thereof.

All modifications which come within the meaning and range of equivalency of the claims are to be embraced within their scope.

1. A method of producing a split-eye, heavy-lift sling, the method comprising:
setting a pair of winding posts to a pre-defined sling length;
winding high-tenacity continuous filament around a first portion of the winding posts a number of turns to complete a first bundle having first and second eyes;
winding high-tenacity continuous filament around a second portion of the winding posts a number of turns to complete a second bundle having first and second eyes;
after completing winding of the first and second bundles, releasing the posts to allow removal of the bundles; and
combining the bundles together to form a sling, while maintaining at least the first eyes of the first and second bundles separate.

2. The method of claim 1, wherein the same continuous filament is wound around the first portion and subsequently around the second portion of the winding posts.

3. The method of any one of the previous claims, wherein the continuous filament is delivered as a multi-filament yarn from a reel.

4. The method of any one of the previous claims, wherein the continuous filament is delivered as a plurality of multi-filament tows, each tow being delivered from a separate reel.

5. The method of any one of the preceding claims, wherein the method further comprises controlling a circumference and/or tension of each turn of the filament around the two posts.

6. The method according to any one of the preceding claims, comprising winding the continuous filament at least 30, preferably at least 50 and, more preferably at least 70 turns around the pair of winding posts for each bundle.

7. The method according to any one of the preceding claims, wherein the winding posts are set to a pre-defined sling length of from 2 m to 150 m, preferably from 5 m to 50 m.

8. The method according to any one of the preceding claims, wherein the first and second portions are separated by a divider configured to keep the first sling and the second sling apart during winding.

9. The method according to any one of the preceding claims, wherein combining the bundles together comprises providing at least one sleeve surrounding the first and second bundles, leaving the eyes exposed.

10. The method according to any one of the preceding claims, wherein maintaining at least the first eyes of the first and second bundles separate comprises forming a soft thimble around each of the first eyes.

11. A split-eye sling comprising first and second identical bundles of high-tenacity continuous filament, combined together to form a heavy-lift sling having a first end and a second end, wherein at least at the first end of the sling, the bundles are separated to form a pair of eyes.

12. The sling according to claim 11, wherein the eyes have a designated eye radius in a range between 11 mm and 750 mm, preferably between 100 mm and 500 mm.

13. The sling according to claim 11 or claim 12, wherein a nominal length variation between the bundles is less than half of the sling diameter.

14. The sling according to any one of claims 11 to 13, wherein the continuous filament has a dpf weight in a range of from 1 dpf to 10 dpf.

15. The sling according to any one of claims 11 to 14, wherein the continuous filament is of high tenacity polymer material, preferably UHMWPE or aramid.

16. The sling according to any one of claims 11 to 15, wherein the bundles comprise multi-filament yarns of between 15000 dtex and 30000 dtex, preferably around 24000 dtex.

17. The sling according to any one of claims 11 to 16, wherein the bundles each have a core diameter in a range between 30 mm and 250 mm.

18. The sling according to any one of claims 11 to 17, having a minimum breaking limit (MBL) of at least 100 t, preferably at least 1000 t, more preferably at least 3500 t.

19. The sling according to any one of claims 11 to 17, further comprising one or more sleeves surrounding both bundles but not the eyes.

20. The sling according to any one of claims 11 to 19, further comprising a pair of soft thimbles surrounding the respective eyes at the first end of the sling.

21. The sling according to claim 20, wherein at the second end of the sling, the bundles are not separate and a single soft thimble surrounds a single eye.

22. The sling according to claim 20 or claim 21, wherein the soft thimbles each have an inner curvature and an outer curvature, configured to form a wrinkle-free surface in contact with an inner radius of the eye and a length of the thimble at the outer curvature is greater than a length of the thimble at the inner curvature.

23. A lifting system comprising a trunnion block having a pair of trunnions and a sling according to any one of claims 11 to 22.

24. The lifting system of claim 23, wherein a first end of the sling is connected to the trunnion block with a respective eye encircling a respective trunnion.

25. The lifting system of claim 23 or claim 24, wherein the sling is releasably connected to the trunnion block.

26. The lifting system of any one of claims 23 to 25, wherein the trunnion block comprises a centre plate having a first end and a second end and the trunnions extend laterally from the first end of the centre plate.

27. The lifting system of claim 26, further comprising retention plates located at respective distal ends of the trunnions.

28. The lifting system of claim 27, further comprising one or more locking pins between the retention plates and the centre plate.

29. The lifting system of any one of claims 26 to 28, further comprising an attachment point at the second end of the centre plate.

30. The lifting system of claim 29, wherein the attachment point comprises a second pair of trunnions and an axis of the second pair of trunnions is parallel to an axis of the first pair of trunnions.

31. The lifting system of claim 30, further comprising a second split-eye sling and the trunnion block serves to connect the first sling to the second sling.

32. The lifting system of any of claims 23 to 31, comprising a plurality of split-eye slings and trunnion blocks, wherein the slings are provided in sets of identical length.

33. The lifting system of claim 32, wherein the system is modular and further comprises one or more spreader beams.

34. The lifting system of claim 33, wherein the trunnion blocks are provided with centre plates of different standard lengths.

35. A trunnion block for use in the system of any one of claims 23 to 34.

36. An apparatus for winding a split-eye sling comprising first and second identical bundles of high-tenacity continuous filament, the apparatus comprising:
a frame;
a pair of winding posts, engageable with the frame to define a predetermined sling length and releasable to allow removal of the sling after winding;
a winding unit, traversable on the frame to wind a continuous filament around the winding posts to form a sling;
wherein each winding post comprises a first portion for the first bundle and a second portion for the second bundle, separated by a dividing region, which keeps the bundles separated until release of the winding posts.

37. The apparatus according to claim 36, wherein the winding unit comprises a moveable platform having a creel carrying at least one reel of the continuous filament.

38. The apparatus according to claim 36 or claim 37, wherein the apparatus comprises an actuator configured to displace at least one of the winding posts in order to set a distance between the winding posts corresponding to the predetermined sling length.

39. The apparatus according to claim any one of claims 36 to 38, wherein the frame comprises rails and the winding unit is configured to move along the rails.

40. The apparatus according to any one of claims 36 to 39, wherein the apparatus comprises a control unit configured to control a position and/or a tension of the continuous filament during winding.

41. The apparatus according to any one of claims 36 to 40, wherein the apparatus is arranged to wind the continuous filament first around the first portion to complete the first bundle and subsequently around the second portion to complete the second bundle.

42. The apparatus according to any one of claims 36 to 41, wherein the winding posts are exchangeable and a diameter of each of the winding posts is in a range between 22 mm and 1500 mm.
